(19) United States
(12) Patent Application Publication
(10) Pub. No.: US 2017/0147064 A1
(43) Pub. Date: May 25, 2017

(54) METHOD AND APPARATUS FOR PROVIDING INFORMATION IN VIRTUAL REALITY ENVIRONMENT

(71) Applicant: SAMSUNG ELECTRONICS CO., LTD., Suwon-si (KR)

(72) Inventors: Jingil YANG, Suwon-si (KR); Yohan LEE, Seongnam-si (KR); Jungeun LEE, Suwon-si (KR); Jaebong CHUN, Suwon-si (KR)

(21) Appl. No.: 15/348,105

(22) Filed: Nov. 10, 2016

(30) Foreign Application Priority Data
Nov. 19, 2015 (KR) 10-2015-0162849

(51) Int. Cl. G06F 3/01; G06T 19/00; G06K 9/00; G06F 3/0481; H04L 29/08; H04L 29/06

(52) U.S. Cl. CPC G06F 3/011; H04L 67/18; H04L 67/38; G06K 9/00335; G06F 3/04815; G06T 19/006

(57) ABSTRACT

A method and an electronic device for providing users with information in a virtual reality environment are provided. The method of providing information in virtual reality environment of an electronic device includes: receiving virtual reality data from a first server, based on location information regarding the electronic device, in a virtual reality space; extracting virtual beacon information including one or more of: a location of the virtual beacon, a direction or distance between the virtual beacon and the terminal in the virtual reality, and information regarding a second server, with identifying information of a virtual beacon, from the received virtual reality data; receiving user context information including information of user related to acquiring the content associated with the virtual beacon; determining whether to transmit the virtual beacon information to the second server, based on the user context information; transmitting at least part of the virtual beacon information to the second server, based on the determination result; receiving content and a display mode from the second server; receiving biometric information; performing the conversion of the content based on the received biometric information; and providing the user with the converted content.

### CROSS-REFERENCE TO RELATED APPLICATION

This application is based on and claims priority under 35 U.S.C. §119 to a Korean patent application filed on Nov. 19, 2015 in the Korean Intellectual Property Office and assigned serial number 10-2015-0162849, the disclosure of which is incorporated by reference herein in its entirety.

### TECHNICAL FIELD

The present disclosure relates generally to a method and an electronic device for providing users with information in a virtual reality environment.

### BACKGROUND

Beacons refer to objects that periodically transmit a signal which needs to be informed. Transmission/reception of a small amount of data (e.g., situation, location, etc.) may be periodically performed on cost effective low power. Various services, such as, marketing, home automation, location identification service, etc. may be provided by using beacons. Beacons may be provided to user equipment (UE) via a beacon generating device installed by a beacon service provider in a reality space.

In order to provide a specific service to a user who needs to receive the service in a virtual space, a method which transmits a particular signal or particular piece of data to a user to receive a service may be used. Content providers may provide the user with signals or data in the form of beacon. The user receiving the service may feel a user experience via the signal or data provided in a form of beacon as if the user uses beacons in a virtual space.

Virtual beacons in a virtual space provided by the method described above may be associated with real beacons in a reality space.

### SUMMARY

Various embodiments of the present disclosure provide a method and an electronic device capable of providing users with information, e.g., virtual beacons, in a virtual reality environment.

In accordance with an example aspect of the present disclosure, a method of providing information in virtual reality environment of an electronic device is provided. The method includes: receiving virtual reality data from a first server, based on location information regarding the electronic device, in a virtual reality space; extracting virtual beacon information including one or more of: a location of the virtual beacon, a direction or distance between the virtual beacon and the terminal in the virtual reality space, and information regarding a second server, with identifying information of a virtual beacon, from the received virtual reality data; receiving user context information including information of user related to acquiring the content associated with the virtual beacon; determining whether to transmit the virtual beacon information to the second server, based on the user context information; transmitting at least part of the virtual beacon information to the second server, based on the determining; receiving content and a display mode from the second server; receiving a user's biometric information; performing conversion of the content based on the received, user's biometric information; and providing the user with the converted content.

In accordance with another example aspect of the present disclosure, an electronic device is provided. The electronic device includes: a display; one or more sensors configured to detect the movement of the electronic device; an input unit comprising input circuitry coupled to or separated from the display; a communication circuit; a processor electrically connected to the display, one or more sensors, the input unit and the communication circuit; and a memory electrically connected to the processor, wherein the memory stores instructions which, when executed, cause the processor to: display a user interface on the display; receive an input of a real-world geographic location via the input circuitry of the input unit; transmit a request for the geographic location to the outside of the electronic device via the communication circuit; receive view data related to the geographic location and including at least one location of interest, from the outside of the electronic device via the communication circuit; display a 3D virtual space, on the display, based on at least part of the received view data; track a location of the electronic device located in the virtual space using at least one of: the sensors and the input unit; receive at least one piece of content related to the location of interest from outside of the electronic device via the communication circuit; and when the location of the electronic device located in the virtual space is within a preset range from the location of interest in the virtual space, display at least one piece of content related to the location of interest on the display.

### BRIEF DESCRIPTION OF THE DRAWINGS

The above and other aspects, features, and advantages of certain embodiments of the present disclosure will become more apparent from the following detailed description, taken in conjunction with the accompanying drawings, in which like reference numerals refer to like elements, and wherein:

FIG. 1 is a diagram illustrating an example network environment including an electronic device according to various example embodiments of the present disclosure;

FIG. 2 is a block diagram illustrating an example electronic device according to various example embodiments of the present disclosure;

FIG. 3 is a block diagram illustrating an example program module according to various example embodiments of the present disclosure;

FIG. 4 is a diagram illustrating example electronic devices that may be required to provide a virtual beacon according to various example embodiments of the present disclosure;

FIG. 5 is a flowchart illustrating an example method for user equipment (UE) to provide a user with a virtual beacon according to various example embodiments of the present disclosure;

FIGS. 6 to 8 are flow diagrams illustrating an example method of providing a virtual beacon according to various example embodiments of the present disclosure;

FIG. 9 is a flowchart illustrating an example method for a virtual reality server to provide a user with a virtual beacon according to various example embodiments of the present disclosure; and

FIG. 10 is a diagram illustrating an example state where a virtual beacon is provided to a user according to various example embodiments of the present disclosure.

### DETAILED DESCRIPTION

The following description, with reference to the accompanying drawings, is provided to assist in a comprehensive understanding of an embodiment of the present disclosure as defined by the claims and their equivalents. It includes various specific details to assist in that understanding but are to be regarded as merely examples. Accordingly, those of ordinary skill in the art will recognize that various changes and modifications of the embodiments described herein may be made without departing from the scope and spirit of the present disclosure. In addition, descriptions of well-known functions and constructions may be omitted for clarity and conciseness.

Expressions such as “include” and “may include” which may be used in the present disclosure denote the presence of the disclosed functions, operations, and constituent elements and do not limit one or more additional functions, operations, and constituent elements. In the present disclosure, terms such as “include” and/or “have” may be construed to denote a certain characteristic, number, step, operation, constituent element, component or a combination thereof, but may not be construed to exclude the existence of, or a possibility of, the addition of one or more other characteristics, numbers, steps, operations, constituent elements, components or combinations thereof.

Furthermore, in the present disclosure, the expression “and/or” includes any and all combinations of the associated listed words. For example, the expression “A and/or B” may include A, may include B, or may include both A and B.

In the present disclosure, expressions including ordinal numbers, such as “first” and “second,” etc., may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of them are user devices. For example, a first element may be referred to as a second element, and similarly, a second element may also be referred to as a first element without departing from the scope of the present disclosure.

In the case where a component is referred to as being “connected” to, or “accessed” by another component, it should be understood that not only is the component directly connected to or accessed by the other component, but there may also exist another component between them. Meanwhile, in the case where a component is referred to as being “directly connected” or “directly accessed” to another component, it should be understood that there is no component therebetween.

The terms used in the present disclosure are only used to describe specific embodiments, and do not limit the present disclosure. As used herein, the singular forms are intended to include the plural forms as well, unless the context clearly indicates otherwise.

In this disclosure, an electronic device may be a device that involves a communication function. For example, an electronic device may be a smart phone, a tablet personal computer (PC), a mobile phone, a video phone, an e-book reader, a desktop PC, a laptop PC, a netbook computer, a personal digital assistant (PDA), a portable multimedia player (PMP), an MP3 player, a portable medical device, a digital camera, or a wearable device (e.g., a head-mounted device (HMD)) such as electronic eyeglasses, electronic clothes, an electronic bracelet, an electronic necklace, an electronic appcessory, or a smart watch), or the like, but is not limited thereto.

According to an embodiment of the present disclosure, an electronic device may be a smart home appliance that involves a communication function. For example, an electronic device may be a TV, a digital video disk (DVD) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame, or the like, but is not limited thereto.

Other embodiments of the electronic device include various medical devices (for example, various kinds of portable medical measuring device (blood glucose meter, heart rate meter, blood pressure meter, or a temperature measuring instrument, etc.), magnetic resonance angiography (MRA), magnetic resonance imaging (MRI), computed tomography (CT), camcorder, or ultrasonography etc., navigation (navigation) devices, global positioning system receiver (GPS) receiver, EDR (event data recorder), flight data recorder (FDR), automotive infotainment (infotainment) devices, marine electronic equipment (e.g., marine navigation systems, gyrocompass, etc.), aviation electronics (avionics), security devices, automotive head unit (head unit), industrial or household robots, financial institutions, automatic teller machine (ATM), point of sales (POS) terminals, or Internet of Things (IoT) devices (e.g. light bulbs, various sensors, electric or gas meters, sprinkler systems, fire alarms, thermostat, street lights, toaster, fitness equipment, hot water tank, a heater, a boiler, etc.), or the like, but is not limited thereto.

According to an embodiment of the present disclosure, an electronic device may be furniture or a building/structure of the portion, an electronic board, an electronic sign-receiving device (electronic signature receiving device), a projector, or various measuring devices (e.g. water, electricity, gas, or a radio wave measuring equipment, etc.), or the like, but is not limited thereto. The electronic device may be one or more combinations of the various devices described above. The electronic device may be a flexible electronic device. In addition, an electronic device is not limited to the above-described device, and may include a new electronic device, in accordance with new technological developments. In this document, the term user refers to a human or an electronic device using the electronic device (for example, an artificial intelligence electronic device).

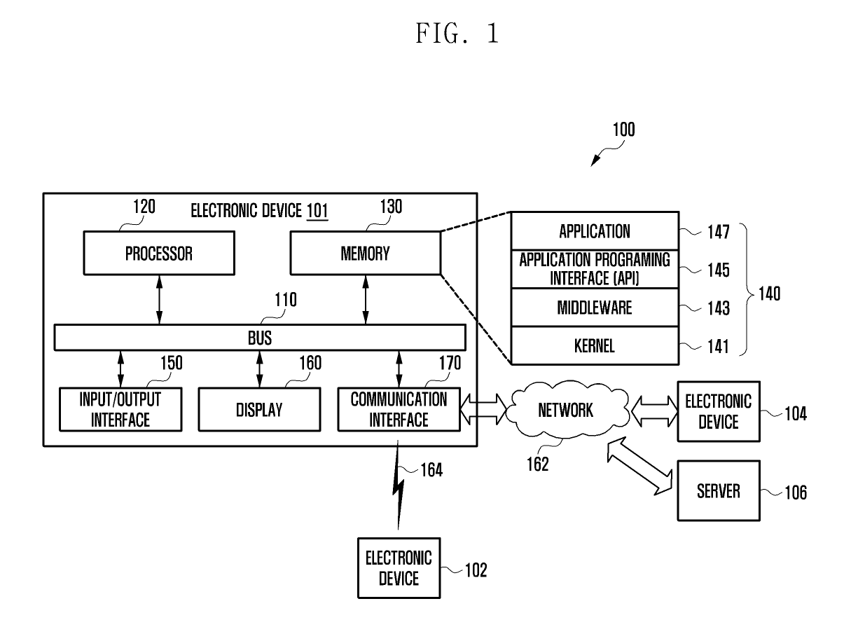

FIG. 1 is a block diagram illustrating an example network environment 100 including an electronic device 101 in accordance with an example embodiment of the present disclosure. Referring to FIG. 1, the electronic device 101 includes a bus 110, a processor 120, a memory 130, an input/output interface (e.g., including input/output circuitry) 150, a display 160, and a communication interface (e.g., including communication circuitry) 170.

The bus 110 may be a circuit designed for connecting the above-discussed elements and communicating data (e.g., a control message) between such elements.

The processor 120 may receive commands from the other elements (e.g., the memory 130, the input/output interface 150, the display 160, or the communication interface 170, etc.) through the bus 110, interpret the received commands, and perform arithmetic or data processing based on the interpreted commands.

The memory 130 may store therein commands or data received from or created at the processor 120 or other elements (e.g., the input/output interface 150, the display 160, or the communication interface 170, etc.). The memory 130 may include programming modules 140 such as a kernel 141, a middleware 143, an application programming interface (API) 145, and an application 147. Each of the programming modules may be composed of software, firmware, hardware, and any combination thereof.

The kernel 141 may control or manage system resources (e.g., the bus 110, the processor 120, the memory 130, etc.) used to execute operations or functions implemented by other programming modules (e.g., the middleware 143, the API 145, and the application 147). Also, the kernel 141 may provide an interface capable of accessing and controlling or managing the individual elements of the electronic device 101 by using the middleware 143, the API 145, or the application 147.

The middleware 143 may serve to go between the API 145 or the application 147 and the kernel 141 in such a manner that the API 145 or the application 147 communicates with the kernel 141 and exchanges data therewith. Also, in relation to work requests received from one or more applications 147 and/or the middleware 143, for example, may perform load balancing of the work requests by using a method of assigning a priority, in which system resources (e.g., the bus 110, the processor 120, the memory 130, etc.) of the electronic device 101 may be used by one or more applications 147.

The API 145 is an interface through which the application 147 is capable of controlling a function provided by the kernel 141 or the middleware 143, and may include, for example, at least one interface or function for file control, window control, image processing, character control, and the like.

The input/output interface 150 may include various input/output circuitry that deliver commands or data, entered by a user through an input/output unit (e.g., circuitry that may include, for example, and without limitation, a sensor, a keyboard, or a touch screen, or the like), to the processor 120, the memory 130, or the communication interface 170 via the bus 110.

The display (e.g., display “module”) 160 may include, for example, a liquid crystal display (LCD), a light emitting diode (LED) display, an organic LED (OLED) display, a micro electro mechanical system (MEMS) display, or an electronic paper display. The display 160 may display various types of content (e.g., text, images, videos, icons, or symbols) for users. The display module 160 may include a touch screen, and may receive, for example, a touch, gesture, proximity, or hovering input by using an electronic device or a part of the user's body.

The communication interface 170 may include various communication circuitry configured to perform communication between the electronic device 101 and the electronic device 104 or the server 106. For example, the communication interface 170 may communicate with any external device by being connected with a network 162 through a wired or wireless communication or via a wireless connection 164.

The wireless communication may include, but not limited to, at least one of wireless fidelity (WiFi), Bluetooth (BT), near field communication (NFC), global navigation satellite system (GNSS), or a cellular communication (e.g., machine type communications (MTC), fifth generation (5G), long term evolution (LTE), long term evolution advanced (LTE-A), code division multiple access (CDMA), wideband code division multiple access (WCDMA), universal mobile telecommunications system (UMTS), wireless broadband (WiBro), global system for mobile communications (GSM), etc.). The GNSS may include at least one of global positioning system (GPS), global navigation satellite system (Glonass), Beidou navigation satellite system (Beidou), Galileo, or the European global satellite-based navigation system. Hereinafter, the terms “GPS” and the “GNSS” may be interchangeably used herein. The wired communication may include, at least one of universal serial bus (USB), high definition multimedia interface (HDMI), RS-232 (recommended standard 232), or plain old telephone service (POTS). The network 162 includes, as a telecommunications network at least one of a computer network (e.g., local area network (LAN) or wide area network (WAN)), the Internet, and a telephone network.

The types of the first and second external electronic devices 102 and 104 may be the same as or different from the type of the electronic device 101. The server 106 may include a group of one or more servers. A portion or all of operations performed in the electronic device 101 may be performed in one or more other electronic devices 102, 104 or the server 106. In the case where the electronic device 101 performs a certain function or service automatically or in response to a request, the electronic device 101 may request at least a portion of functions related to the function or service from another electronic device 102, 104 or the server 106 instead of, or in addition to, performing the function or service for itself. The other electronic device 102, 104 or the server 106 may perform the requested function or additional function, and may transfer a result of the performance to the electronic device 101. The electronic device 101 may additionally process the received result to provide the requested function or service. To this end, for example, a cloud computing technology, a distributed computing technology, or a client-server computing technology may be used.

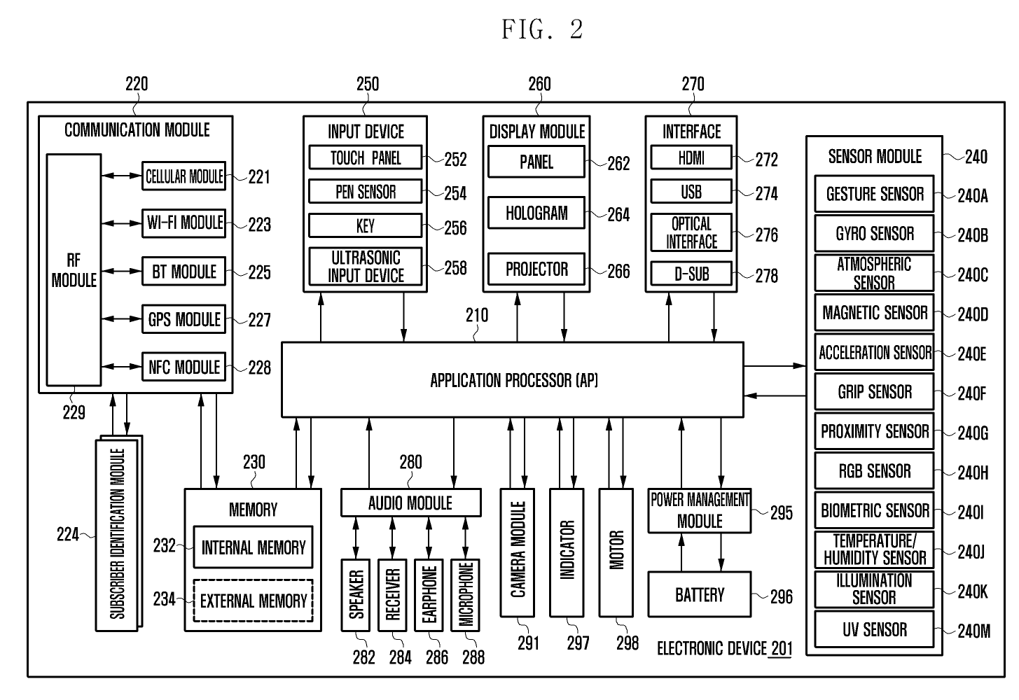

FIG. 2 is a block diagram illustrating an example electronic device 201 in accordance with an example embodiment of the present disclosure. The electronic device 201 may form, for example, the whole or part of the electronic device 101 illustrate in FIG. 1. Referring to FIG. 2, the electronic device 201 includes at least one application processor (AP) 210, a communication module (e.g., including communication circuitry) 220, a subscriber identification module (SIM) card 224, a memory 230, a sensor module 240, an input unit (e.g., including input circuitry) 250, a display 260, an interface (e.g., including interface circuitry) 270, an audio module 280, a camera module 291, a power management module 295, a battery 296, an indicator 297, and a motor 298.

The AP 210 may drive an operating system or applications, control a plurality of hardware or software components connected thereto, and also perform processing and operation for various data including multimedia data. The AP 210 may be formed of a system-on-chip (SoC), for example. According to an embodiment of the present disclosure, the AP 210 may further include a graphic processing unit (GPU).

The communication module 220 (e.g., the communication interface 170) may include various communication circuitry configured to perform data communication with the electronic device 104 or the server 106 connected to the electronic device 201 (e.g., the electronic device 101) through the network. According to an embodiment of the present disclosure, the communication module 220 may include various communication circuitry, such as, for example, and without limitation, a cellular module 221, a WiFi module 223, a BT module 225, a GNSS module 227, an NFC module 228, and an RF (radio frequency) module 229.

The cellular module 221 may offer a voice call, a video call, a message service, an internet service, and the like through a communication network (e.g., machine type communications (MTC), fifth generation (5G), long term evolution (LTE), long term evolution advanced (LTE-A), code division multiple access (CDMA), wideband code division multiple access (WCDMA), universal mobile telecommunications system (UMTS), wireless broadband (WiBro), global system for mobile communications (GSM), wireless fidelity (Wi-Fi), Bluetooth, and near field communications (NFC) etc.). Additionally, the cellular module 221 may perform identification and authentication of the electronic device in the communication network, using the SIM card 224. According to an embodiment of the present disclosure, the cellular module 221 may perform at least part of functions the AP 210 may provide. For example, the cellular module 221 may perform at least part of a multimedia control function. Each of the WiFi module 223, the BT module 225, the GNSS module 227 and the NFC module 228 may include a processor for processing data transmitted or received. Although FIG. 2 shows the cellular module 221, the WiFi module 223, the BT module 225, the GNSS module 227 and the NFC module 228 as different blocks, at least part of them may be contained in a single IC (integrated circuit) chip or a single IC package.

The RF module 229 may transmit and receive data, e.g., RF signals or any other electric signals. The RF module 229 may include a transceiver, a PAM (power amp module), a frequency filter, an LNA (low noise amplifier), and the like. Although FIG. 2 shows that the cellular module 221, the WiFi module 223, the BT module 225, the GNSS module 227 and the NFC module 228 share the RF module 229, at least one of them may perform transmission and reception of RF signals through a separate RF module.

The SIM card 224 may include, for example, an embedded SIM including a user identification module, and may include unique identification information (e.g., an integrated circuit card identifier (ICCID)) or subscriber information (e.g., international mobile subscriber identity (IMSI)).

The memory 230 includes an internal memory 232 and an external memory 234. The memory 230 may be, for example, the memory 130 illustrated in FIG. 1. The internal memory 232 may include, for example, at least one of a volatile memory (e.g., a dynamic RAM (DRAM), a static RAM (SRAM), a synchronous dynamic RAM (SDRAM), etc.), and a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a not AND (NAND) flash memory, a not OR (NOR) flash memory, etc.). According to an embodiment of the present disclosure, the internal memory 232 may be in the form of a solid state drive (SSD). The external memory 234 may further include a flash drive, for example, a compact flash (CF), a secure digital (SD), a micro-secure digital (micro-SD), a mini-secure digital (mini-SD), an extreme digital (xD), a memory stick, and the like. The external memory 234 may be functionally connected to the electronic device 201 through various interfaces.

The sensor module 240 may measure physical quantity or sense an operating status of the electronic device 201, and then convert measured or sensed information into electric signals. The sensor module 240 includes, for example, at least one of a gesture sensor 240A, a gyro sensor 240B, an atmospheric (e.g., barometer or barometric) sensor 240C, a magnetic sensor 240D, an acceleration sensor 240E, a grip sensor 240F, a proximity sensor 240G, a color sensor 240H (e.g., RGB or “red, green, blue” sensor), a biometric sensor 240I, a temperature-humidity sensor 240J, an illumination sensor 240K, and a UV (ultraviolet) sensor 240M. Additionally or alternatively, the sensor module 240 may include, e.g., an E-nose sensor, an EMG (electromyography) sensor, an EEG (electroencephalogram) sensor, an ECG (electrocardiogram) sensor, an IR (infrared) sensor, an iris scan sensor, or a finger scan sensor. Also, the sensor module 240 may include a control circuit for controlling one or more sensors equipped therein.

The input unit 250 includes various input circuitry, such as, for example, and without limitation, a touch panel 252, a digital pen sensor 254, a key 256, or an ultrasonic input unit 258. The touch panel 252 may recognize a touch input in a manner of capacitive type, resistive type, infrared type, or ultrasonic type. Also, the touch panel 252 may further include a control circuit. The touch panel 252 may further include a tactile layer. In this case, the touch panel 252 may offer a tactile feedback to a user. The pen sensor 254 (e.g., a digital pen sensor), for example, may be implemented by using a method identical or similar to a method of receiving a touch input from the user, or by using a separate sheet for recognition. For example, a key pad or a touch key may be used similar to the keys 256. The ultrasonic input unit 258 enables the terminal to sense a sound wave by using a microphone 288 of the terminal through a pen generating an ultrasonic signal, and to identify data.

The display 260 (e.g., the display 160) includes a panel 262, a hologram 264, or a projector 266. The panel 262 may have a flexible, transparent or wearable form. The panel 262 may be formed of a single module with the touch panel 252. The hologram 264 may show a stereoscopic image in the air using interference of light. The projector 266 may project an image onto a screen, which may be located at the inside or outside of the electronic device 201. According to an embodiment of the present disclosure, the display 260 may further include a control circuit for controlling the panel 262, the hologram 264, and the projector 266.

The interface 270 may include various interface circuitry, such as, for example, and without limitation, an HDMI (high-definition multimedia interface) 272, a USB (universal serial Bus) 274, an optical interface 276, or a D-sub (D-subminiature) 278. The interface 270 may be contained, for example, in the communication interface 170 illustrated in FIG. 1. Additionally or alternatively, the interface 270 may include, for example, an MHL (mobile high-definition link) interface, an SD (secure digital) card/MMC (multi-media card) interface, or an IrDA (infrared data association) interface.

The audio module 280 may perform a conversion between sounds and electric signals. At least part of the audio module 280 may be contained, for example, in the input/output interface 150 illustrated in FIG. 1. The audio module 280 may process sound information inputted or outputted through a speaker 282, a receiver 284, an earphone 286, or a microphone 288.

The camera module 291 is a device capable of obtaining still images and moving images. According to an embodiment of the present disclosure, the camera module 291 may include at least one image sensor (e.g., a front sensor or a rear sensor), a lens, an ISP (image signal processor, not shown), or a flash (e.g., LED or xenon lamp, not shown).

The power management module 295 may manage electric power of the electronic device 201. The power management module 295 may include, for example, a PMIC (power management integrated circuit), a charger IC, or a battery charge gauge. The PMIC may be implemented by, for example, an IC or an SoC semiconductor. Charging methods may be classified into a wired charging method and a wireless charging method. A wireless charging type may include, for example, a magnetic resonance type, a magnetic induction type, or an electromagnetic type. Any additional circuit for wireless charging may be further used such as a coil loop, a resonance circuit, or a rectifier. The battery gauge may measure the residual charge amount of the battery 296 and a voltage, current or temperature in a charging process. The battery 296 may store or create electric power therein and supply electric power to the electronic device 201. The battery 296 may be, for example, a rechargeable battery or a solar battery.

The indicator 297 may show thereon a current status (e.g., a booting status, a message status, or a recharging status) of the electronic device 201 or of its part (e.g., the AP 210). The motor 298 may convert an electric signal into a mechanical vibration. The electronic device 201 may include a specific processor (e.g., GPU) for supporting a mobile TV. This processor may process media data that comply with standards of DMB (digital multimedia broadcasting), DVB (digital video broadcasting), or MediaFlo.

Each of the above-discussed elements of the electronic device disclosed herein may be formed of one or more components, and its name may vary according to the type of the electronic device. The electronic device disclosed herein may be formed of at least one of the above-discussed elements without some elements or with additional other elements. Some of the elements may be integrated into a single entity that still performs the same functions as those of such elements before integrated.

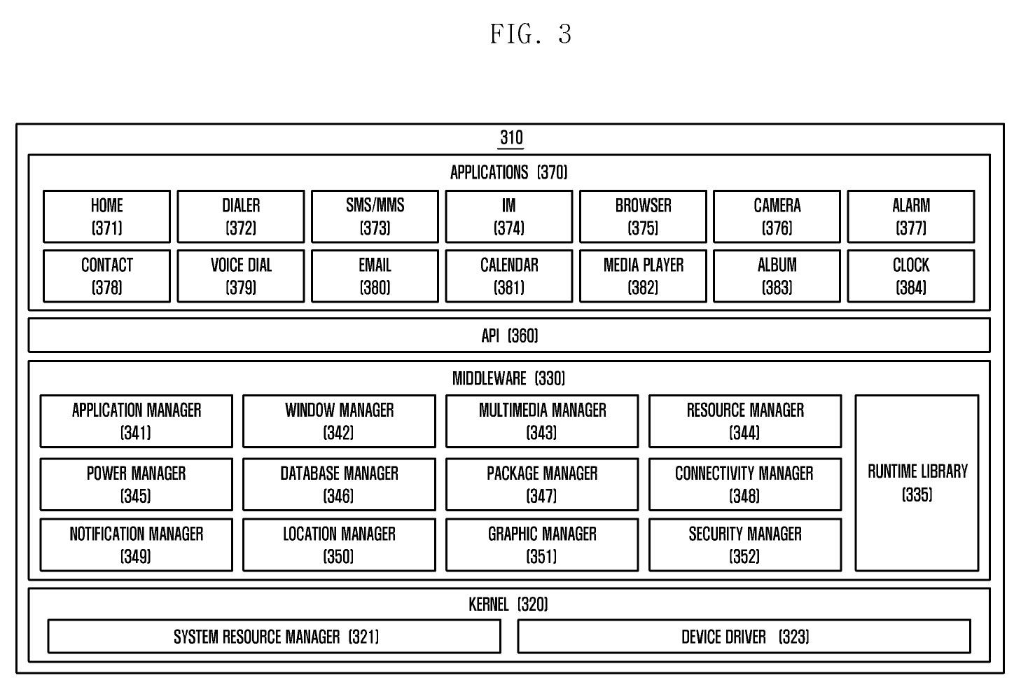

FIG. 3 is a block diagram illustrating an example program module, according to an example embodiment of the present disclosure.

Referring to FIG. 3, a program module 310 (e.g., the program 140) may include an operating system (OS) controlling resources related to the electronic device (e.g., the electronic device 101) and/or various applications (e.g., the application 147) that are driven on the operating system. The operating system may include, e.g., Android™, iOS™, Windows™, Symbian™, Tizen™, or Bada™.

The program module 310 includes a kernel 320, middleware 330, an API 360, and/or an application 370. At least a part of the program module 310 may be preloaded on the electronic device or may be downloaded from the electronic device 104 or the server 106.

The kernel 320 (e.g., the kernel 141 of FIG. 1) may include, e.g., a system resource manager 321 and/or a device driver 323. The system resource manager 321 may perform control, allocation, or recovery of system resources and may include a process managing unit, a memory managing unit, and/or a file system managing unit. The device driver 323 may include, e.g., a display driver, a camera driver, a Bluetooth driver, a shared memory driver, a USB driver, a keypad driver, a Wi-Fi driver, an audio driver, or an inter-process communication (IPC) driver.

The middleware 330 may provide various functions to the application 370 through the API 360 so that the application 370 may efficiently use limited system resources in the electronic device or provide functions jointly required by applications 370. The middleware 330 (e.g., middleware 143) includes at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and/or a security manager 352.

The runtime library 335 may include a library module used by a compiler to add a new function through a programming language while, e.g., the application 370 is being executed. The runtime library 335 may perform input/output management, memory management, and/or arithmetic functions.

The application manager 341 may manage the life cycle of at least one application of, e.g., the applications 370. The window manager 342 may manage graphical user interface (GUI) resources used on the screen. The multimedia manager 343 may determine formats necessary to play various media files and use a codec appropriate for a format to perform encoding or decoding on media files. The resource manager 344 may manage resources, such as source code of at least one of the applications 370, memory and/or storage space.

The power manager 345 may operate together with, e.g., a basic input/output system (BIOS) to manage battery or power and provide power information necessary for operating the electronic device. The database manager 346 may generate, search, and/or query a database to be used in at least one of the applications 370. The package manager 347 may manage installation or update of an application that is distributed in the form of a package file.

The connectivity manager 348 may manage wireless connectivity, such as, e.g., Wi-Fi or BT. The notification manager 349 may display or notify an event, such as an incoming message, appointment, and/or proximity notification without interfering with the user. The location manager 350 may manage location information on the electronic device. The graphic manager 351 may manage graphic effects to be offered to the user and their related user interface. The security manager 352 may provide various security functions necessary for system security and/or user authentication. When the electronic device (e.g., the electronic device 101) has telephony capability, the middleware 330 may further include a telephony manager for managing voice call and/or video call functions of the electronic device. The middleware 330 may include various functions of the above-described components. The middleware 330 may provide a specified module per type of operating system to provide a differentiated function. Further, the middleware 330 may dynamically omit some existing components or add new components.

The API 360 (e.g., the API 145) may be a set of, e.g., API programming functions and may have different configurations depending on operating systems. For example, in the case of Android or iOS, one API set may be provided per platform, and in the case of Tizen, two or more API sets may be offered per platform.

The application 370 (e.g., the application processor 147) includes one or more applications that may provide functions such as, e.g., a home 371, a dialer 372, a short message service (SMS)/multimedia messaging service (MMS) 373, an instant message (IM) 374, a browser 375, a camera 376, an alarm 377, a contact 378, a voice dial 379, an email 380, a calendar 381, a media player 382, an album 383, or a clock 384, a health-care (e.g., measuring the degree of workout or blood sugar level), and/or environmental information (e.g., provision of air pressure, moisture, or temperature information). The application 370 may include information exchanging application supporting information exchange between the electronic device (e.g., the electronic device 101) and an external electronic device 102 and 104. Examples of the information exchange application may include, but is not limited to, a notification relay application for transferring specific information to the external electronic device, or a device management application for managing the external electronic device. For example, a notification relay application may include a function for relaying notification information generated from other applications of the electronic device (e.g., the SMS/MMS application, the email application, the health-care application, or the environmental information application) to the external electronic devices 102 and 104. Further, the notification relay application may receive notification information from, e.g., the external electronic device and may provide the received notification information to the user. A device management application may perform at least some functions of the external electronic device 102 or 104 such as, for example, turning on/off the external electronic device (or some components of the external electronic device), control brightness (or resolution) of the display, etc. The device management application may manage (e.g., install, delete, or update) an application operating in the external electronic device or a service (e.g., call service or message service) provided from the external electronic device.

The application 370 may include an application (e.g., a health-care application) selected depending on the attribute (e.g., as an attribute of the electronic device, the type of electronic device is a mobile medical device) of the external electronic device 102 and 104. The application 370 may include an application received from the server 106 or electronic devices 102 and 104. The application 370 may include a preloaded application or a third party application downloadable from a server. The names of the components of the program module 310 may be vary depending on the type of operating system. At least a part of the program module 310 may be implemented in software, firmware, hardware, or in a combination of two or more thereof. At least a part of the programming module 310 may be implemented (e.g., executed) by e.g., a processor (e.g., the AP 210). At least a part of the program module 310 may include e.g., a module, a program, a routine, a set of instructions, a process, and the like for performing one or more functions.

The term “module” as used in this disclosure may refer to a certain unit that includes one of hardware (e.g., circuitry), software and firmware or any combination thereof. The term module may be interchangeably used with unit, logic, logical block, component, or circuit, for example. The module may be the minimum unit, or part thereof, which performs one or more particular functions. The module may be formed mechanically or electronically. For example, the module disclosed herein may include at least one of a processor (e.g., processing circuitry, CPU, etc.) ASIC (application-specific integrated circuit) chip, FPGAs (field-programmable gate arrays), and programmable-logic device, which have been known or are to be developed.

In an embodiment of the present disclosure, an electronic device is implemented in such a way as to include: a display; one or more sensors for detecting the movement of the electronic device; an input unit comprising input circuitry coupled to or separated from the display; a communication circuit; a processor electrically connected to the display, one or more sensors, the input unit and the communication circuit; and a memory electrically connected to the processor, wherein the memory stores instructions which, when executed, cause the processor to: display a user interface on the display; receive a user input of a real-world geographic location via the input unit; transmit a request for the geographic location to the outside of the electronic device via the communication circuit; receive view data, which is related to the geographic location and includes at least one location of interest, from the outside of the electronic device via the communication circuit; display a 3D virtual space, on the display, based on at least part of the received view data; track a location of the electronic device located in the virtual space using at least one of the following: the sensors and the input unit; receive at least one piece of content related to the location of interest from outside of the electronic device via the communication circuit; and when the location of the electronic device located in the virtual space is within a preset range from the location of interest in the virtual space, display at least one piece of content related to the location of interest on the display.

In the electronic device according to an embodiment, the user interface includes a map of the real world, and the user input includes a touch, a voice or a gesture applied to the map.

In the electronic device according to an embodiment, the user interface includes a box for an address, and the user input includes text indicating an address for the real world.

In the electronic device according to an embodiment, the instructions enable the processor to receive: 3D view data from a first server; and at least one piece of content: from a second server; or from the second server via the first server.

In the electronic device according to an embodiment, the instructions enable the processor to receive: at least one piece of content before the virtual viewpoint of the viewer enters a preset range from the location of interest in the virtual space.

In the electronic device according to an embodiment, the instructions enable the processor to receive: at least one piece of content after the virtual viewpoint of the viewer enters a preset range from the location of interest in the virtual space.

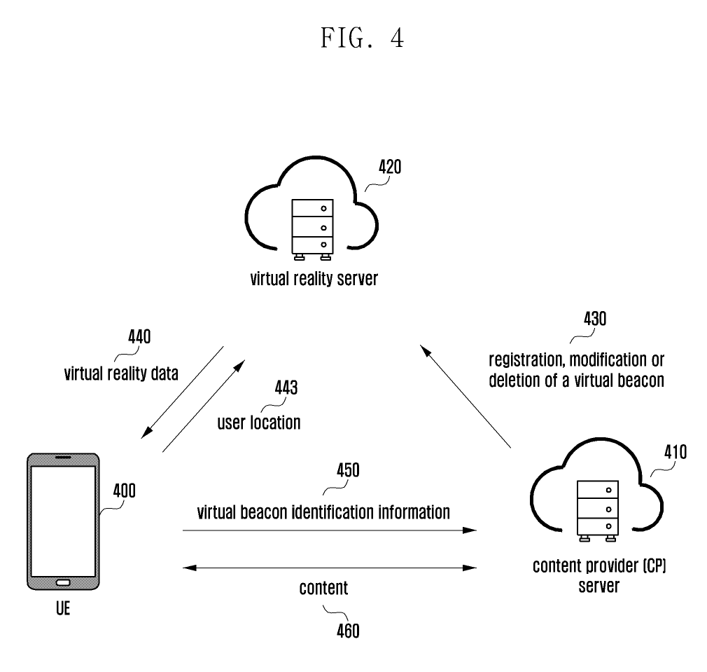

FIG. 4 is a diagram illustrating example electronic devices that may be required to provide a virtual beacon according to various example embodiments of the present disclosure.

In an embodiment of the present disclosure, an electronic device is capable of including user equipment (UE) 400, a virtual reality server 420 or a content provider (CP) server 410.

The virtual reality server 420 is capable of providing UE 400 with virtual reality data 440. When the user is located within a user's preset range of virtual reality location, the virtual reality data may contain information related to the virtual reality location, which is hereafter called a virtual beacon. The virtual beacon may include: an identifier distinguished from other virtual beacons, location information where a virtual beacon is generated, the range of a virtual beacon, the direction or the distance between a location in the virtual reality space where a virtual beacon is generated and a user in the virtual reality space, additional information regarding a virtual beacon, and information regarding the content provider server 410 configured to provide content related to a virtual beacon.

The virtual reality server 420 is capable of performing the registration, modification or deletion of a virtual beacon (as indicated by reference number 430) in a database of the virtual reality server 420 or a separate database server, according to a request by the content provider server 410 or a management policy of the virtual reality server 420 for a virtual beacon. The virtual reality server 420 is capable of acquiring a user's location information in the virtual reality space from the UE 400. The ‘user's location information’ may refer to a location of a user received from the UE 400 or a location of a user that the virtual reality server 420 directly obtained in the process of communicating with the UE 400. The user's location information may contain current location information in the real world where the UE connected to the virtual reality server 420 is currently located and a user's specified location. An example of the current location information in the real world is a location in the real world where the UE 400 is located.

The virtual reality server 420 is capable of checking whether a virtual beacon related to a user's location in the virtual reality space exists in a database. When the virtual reality server 420 ascertains that one or more virtual beacons exist in a database, it is capable of searching the database for virtual reality data including the virtual beacon, etc., and transmitting the search result to the UE 400. For example, the virtual reality server 420 checks whether a user's location exists within the range of a virtual beacon stored in a database or whether a user's location exists within a certain distance from a location where a virtual beacon is generated, thereby determining the relevance. In addition, the determination of relevance may be performed, considering the direction or user context information. The virtual reality server 420 is capable of transmitting, to the UE 400, information regarding the direction or distance between the virtual beacon and the user. The distance information may refer to a numerical value transformed from a distance or a level transformed from a degree of proximity.

In an embodiment, the user context information may include information of user related to acquiring the content associated with the virtual beacon. For example, the user context information may include a user's sightlines in the reality space or the virtual reality space, a direction of a user's body or face, a user's voice, a user's gesture, and a user's location information.

In an embodiment, the virtual reality server 420 and the content provider server 410 may be identical to or differ from each other, physically, according to the type of device.

In the present disclosure, although the UE 400, the virtual reality server 420 and the content provider server 410 are described in such a way that they are distinguished from each other, it should be understood that they are not intended to limit the operation entities nor to represent separate devices, but are used to describe functions of devices for providing a virtual beacon. The electronic devices may be designed so that their functions are duplicated, according to embodiments.

In an embodiment, a content provider that manages the content provider server 410 may be an entity for providing content 460 related to a virtual beacon. The content provider that provides content 460 via the content provider server 410 is capable of performing the registration, modification or deletion of a virtual beacon related to the content 460 in the virtual reality server 420. The virtual beacon, registered by the content provider in the virtual reality server 420, may contain one or more of the following: information regarding a virtual beacon, information regarding content, and information regarding a content provider. The virtual beacon information may contain identification information regarding a virtual beacon, classification information, location information where a virtual beacon is generated, a range of transmission or transfer of a virtual beacon (including distance, area, and direction). The information regarding content may contain virtual beacon-related content (including an event or a service), content identification information, content classification information, a target to receive content, and a period of time to provide content. The information regarding a content provider may contain information regarding the connection or access (e.g., URL) to a content provider server 410, a contact of a content provider, content provider identification information, etc.

In an embodiment, the virtual beacon may include: information regarding a sensor installed in the real world, information regarding a real beacon corresponding to a virtual beacon (e.g., a real beacon identifier (ID), a location where a real beacon is generated, a range of transmission or transfer of a real beacon, information regarding a server and identification information regarding a content provider for providing content in the real space, information regarding levels of signal strength according to distances in beacon communication mode and information regarding beacon communication mode used in the reality space, etc.).

In an embodiment, the virtual beacon information may be configured to be identical or similar, in format, to real beacon information used in the reality space. Therefore, the virtual beacon identification information 450 may be identical to the real beacon identifier that the content provider provides in the reality space. The virtual beacon information may contain information to identify whether the source of a beacon is in the virtual space or the reality space.

In an embodiment, when the virtual reality server 420 transmits a virtual beacon to the UE 400, the virtual beacon may contain the content information. After receiving the virtual beacon, the UE 400 is capable of requesting content information, based on the received virtual beacon, from the content provider server 410 (or the virtual reality server 420).

In an embodiment, when the content provider server 410 receives virtual beacon information (e.g., virtual beacon identification information 450) from the UE 400, it is capable of providing content 460 corresponding to the received information to the UE 400.

In an embodiment, the UE 400 refers to devices that are capable of receiving virtual reality data from the virtual reality server 420 and providing the received virtual reality data to the user. Examples of the UE 400 are electronic devices capable of providing virtual reality, such as smartphones, tablets, head mounted devices (HMDs), TVs, projectors, etc.

In an embodiment, the UE 400 is capable of transmitting a user's location 443 in the virtual reality space to the virtual reality server 420. The UE 400 may also transmit, to the virtual reality server 420, information regarding the UE 400, information that the virtual reality server 420 needs to implement the virtual reality or to search for the virtual reality data, a user's information, information obtained via the sensors included in the UE 400 or nearby sensors of the UE 400, etc.

In an embodiment, the UE 400 is capable of checking whether a virtual beacon is included in the virtual reality data received from the virtual reality server 420. To this end, the virtual reality data may contain information to identify a virtual beacon.

In an embodiment, the UE 400 is capable of extracting information regarding a virtual beacon from the virtual reality data. The UE 400 is capable of acquiring content from the extracted virtual beacon information. When the virtual beacon information contains content information, the UE 400 is capable of directly acquiring content from the virtual beacon information. Alternatively, the UE 400 is capable of acquiring content from the outside, using the virtual beacon information. The UE 400 is capable of acquiring or determining a path to access the content provider server or a mode for communicating with the content provider, using the extracted virtual beacon information. Through the access path and the communication mode, the UE 400 is capable of transmitting virtual beacon information (e.g., virtual beacon identification information 450) to the content provider server 410 and receiving content 460 related to a virtual beacon from the content provider. The UE 400 is capable of analyzing user context information, via one or more sensors of the UE 400 or the nearby sensors of the UE 400, and using the analyzed information when receiving a virtual beacon. For example, the UE 400 is capable of detecting a user's sightlines, the direction of a user's body, a user's gesture, or a user's location where the user is inside or outside the room, in the virtual space or the reality space, and determining: whether it receives a virtual beacon, whether it processes the received virtual beacon information, or whether it provides the user with the received virtual beacon information.

In an embodiment, the UE 400 is capable of determining whether it provides the user with content 460 received from the content provider server 410, using the user context information. For example, the UE 400 is capable of detecting a degree of user interest (e.g., a case where the user looks at or points the finger to the virtual beacon in the virtual space) based on the user context information, and using the degree of user interest to determine whether it provides the user with content 460 related to a virtual beacon.

In an embodiment, the UE 400 is capable of storing one or more received pieces of virtual beacon information in its database, in a database of the virtual reality server 420 or the content provider server 410, or a separate server such as a cloud server. The virtual beacon information may be stored in one of the databases described above, along with content information, information regarding a content provider, information regarding the UE 400 or a user that has received a virtual beacon, time information (e.g., a reception time, a storage time, an update time, etc.), a virtual beacon user's note (memo), etc.

In an embodiment, the virtual beacon included in the virtual reality data received by the UE 400 may be compatible with the real beacon in the format of data. The virtual beacon and the real beacon may be stored in a database of the same device or in databases of different devices.

When the virtual beacon and the real beacon are compatible with each other in the format of data, the virtual beacon and the real beacon may further contain information to identify whether the source of the beacon is in the virtual space or the reality space, respectively. The virtual beacon and the real beacon, stored in the database, may be mutually compared with each other and synchronized with each other.

In an embodiment, a virtual beacon may include information related to a location of the real world.

When a user approaches a place corresponding to the location of the real world in the real world space, using a location of the real world, included in the virtual beacon received from the virtual reality space, the present disclosure is capable of providing the user with a service as if the user receives a real beacon signal. That is, although a physical beacon generating device does not exist in the real world, when a user has been provided with a virtual beacon in the virtual space, the user may be provided with a beacon service at the location of the real world corresponding to the virtual beacon. Therefore, the content provider of the real world is capable of providing a beacon service, without the installation of a beacon generating device in the reality space.

In an embodiment, the virtual beacon may further include setup information, in addition to information related to locations of the real world. When a user approaches a location of the real world corresponding to the virtual beacon, the present disclosure is capable of activating beacon communication modes, such as Wi-Fi, BLE, ultrasonic waves, etc., and directly receiving a beacon of the real world via the activated beacon communication mode.

After receiving a real beacon, the present disclosure is capable of using the real beacon to classify content to be provided to users, determine a user's preference, or identify user context information, based on a condition as to whether a virtual beacon related to the real beacon has been stored in a database, etc. For example, when a user who has been issued with a virtual beacon receives a real beacon from the real world, the present disclosure is capable of providing the user with an additional benefit, such as coupons.

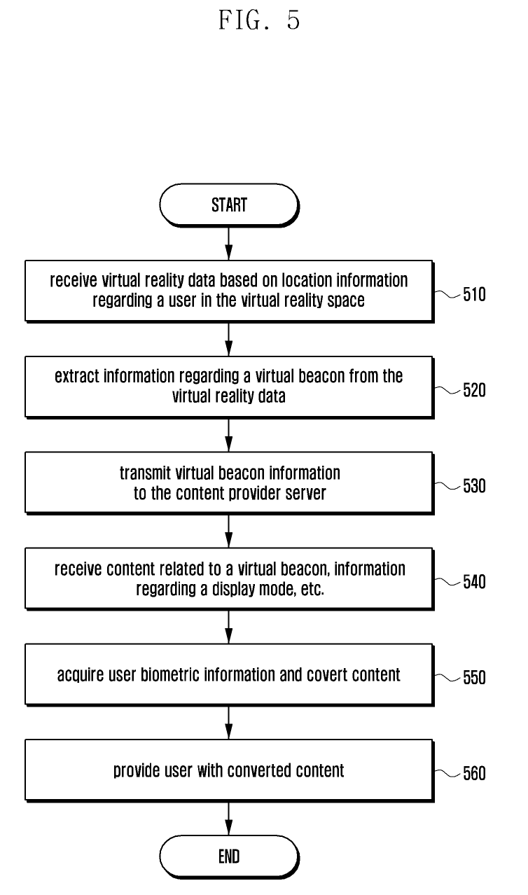

FIG. 5 is a flowchart illustrating an example method for user equipment (UE) 400 to provide a user with a virtual beacon according to various example embodiments of the present disclosure.

The UE 400 is capable of receiving virtual reality data from the virtual reality server 420, based on location information regarding a user in the virtual reality space in operation 510.

The UE 400 is capable of extracting information regarding a virtual beacon from the virtual reality data in operation 520.

The UE 400 is capable of transmitting virtual beacon information to the content provider server 410 in operation 530. In this example, the UE 400 may further consider user context information. In an embodiment, the user context information may include information of user corresponding to acquiring the content associated with the virtual beacon. For example, the user context information may include a user's sightlines in the reality space or the virtual reality space, a direction of a user's body or face, a user's voice, a user's gesture, and a user's location information. The UE 400 is capable of analyzing user context information, via one or more sensors of the UE 400 or the nearby sensors of the UE 400, and using the analyzed information to acquire content 460 regarding a virtual beacon. For example, the UE 400 is capable of detecting sightlines, a direction of body, a gesture of the user who is holding the UE 400, or a location where the user is inside or outside the room, in the virtual space or the reality space, and determining: whether it processes the virtual beacon or whether it transmits the virtual beacon information to the content provider server 410. The UE 400 is capable of transmitting the user context information along with the virtual beacon information to the content provider server 410 so that the content provider server 410 can use the user context information along with the virtual beacon information to determine content to be transmitted.

In an embodiment, information regarding a virtual beacon that the UE 400 transmits to the content provider server 410 may be virtual beacon identification information 450. The UE 400 may also transmit part or all of the information regarding the virtual beacon to the content provider server 410.

The UE 400 is capable of receiving, from the content provider server 410, content 460 related to a virtual beacon, information regarding a display mode, etc. in operation 540. The content 460 provided by the content provider server 410 may include events and services related to a virtual beacon. The information regarding a display mode provided by the content provider server 410 may be information related to methods of displaying or storing content 460 on the UE 400. When the UE 400 has installed an application of the content provider server 410 therein, it is capable of communicating with the content provider server 410 and displaying content 460 received from the content provider server 410, via the application. The UE 400 is capable of displaying the received content 460 in various modes according to the features of the content 460. The UE 400 is capable of receiving information regarding the content 460 and storing the received information in the database. The UE 400 is capable of receiving part of the information regarding the content 460, according to the degree of importance, the priority, the communication capability, a degree of user interest, etc., and accessing the remaining information later. The UE 400 is capable of determining whether it provides the user with content 460 received from the content provider server 410, using the user context information. For example, the UE 400 is capable of detecting a degree of user interest (e.g., a case where the user looks at or points the finger to the virtual beacon in the virtual space) based on the user context information, and using the degree of user interest to determine whether it provides the user with content 460 related to a virtual beacon.

The UE 400 is capable of determining whether it provides the user with content 460 received from the content provider server 410, using the user context information. For example, the UE 400 is capable of detecting a degree of user interest (e.g., a case where the user looks at or points the finger to the virtual beacon in the virtual space) based on the user context information, and using the degree of user interest to determine whether it provides the user with content 460 related to a virtual beacon.

The UE 400 is capable of receiving a user's biometric information from the user in operation 550. The UE 400 is capable of receiving a user's biometric information from the user, using a pre-stored user's profile or at least one sensor of the UE 400. A user's biometric information may include a user's body information, such as height, body weight, a condition as to whether to have disabilities etc., means for recognizing biometrics such as fingerprints, iris, etc., and so on. The UE 400 is capable of adapting or converting content, received from the content provider server 410, for the user, based on the received user's biometric information, an providing the user with the adapted content. Alternatively, the UE 400 is capable of adapting content for individual users according to users' preferences, and providing the users with adapted content, respectively.

The UE 400 is capable of providing users with content 460 adapted or converted for individual users, respectively, based on a display mode, etc. received from the content provider server 410 in operation 560.

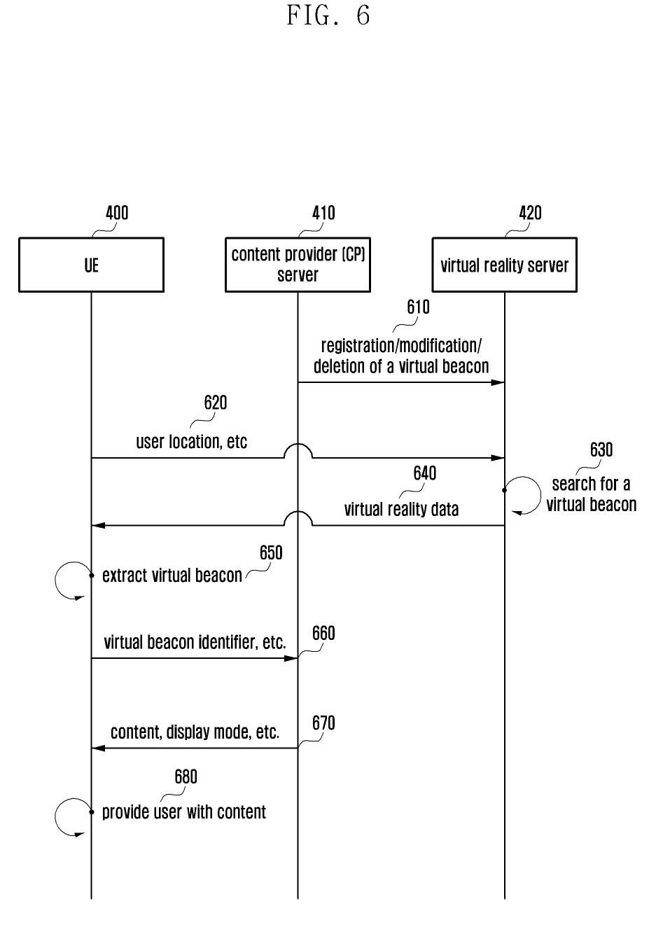

FIGS. 6 to 8 are flow diagrams illustrating an example method of providing a virtual beacon according to various example embodiments of the present disclosure.

FIG. 6 is a flow diagram illustrating an example first embodiment of an example method of providing a virtual beacon in a virtual reality space.

A content provider which needs to provide services via a virtual beacon is capable of registering the virtual beacon related to content (including events or services) in a virtual reality server 420 via a content provider server 410 in operation 610. Content provided via a virtual beacon may include part or all of content which can be provided via a real beacon.

In an embodiment, the virtual space may refer to a simulation space corresponding to the real world. For example, a user actually located in New York may be located around the Eiffel Tower in Paris in the virtual space via the UE 400, provided by the virtual reality server 420. The virtual space is a simulation space created from the real surrounding area of the Eiffel Tower. A manager at a real Starbucks store near the Eiffel Tower may register a virtual beacon in a virtual Starbucks store which is simulated with the same location as the real world. When a user connects to the virtual space simulating the real area around the Eiffel Tower, the user may approach the virtual Starbucks store near the Eiffel Tower and receive the registered virtual beacon. The received virtual beacon may be stored in the virtual reality server 420 or the UE 400. When the user actually approaches a real Starbucks store near the Eiffel Tower in the real world, the user may feel as if the user receives the beacon from the real store, using the virtual beacon which has been received before, or the user may be provided a purchase benefit service, advertisements or marketing services, customized by combining the beacon of the real world with the virtual beacon.

In an embodiment, the content provider is capable of performing the registration, modification and deletion of the virtual beacon information in the virtual reality server 420 in operation 610. For example, the registration of a virtual beacon may be performed in such a way as to determine an area in the virtual space where a virtual beacon can be generated.

The virtual reality server 420 is capable of receiving information regarding a user's location from the UE 400 or directly determining information regarding a user's location in operation 620.

The virtual reality server 420 is capable of searching a database for a virtual beacon related to location information, using a user's location information, etc., in operation 630. When the virtual reality server 420 receives a request from the UE 400 or ascertains that a preset condition (e.g., a case where the user or UE enters a pre-determined place in the virtual space) is satisfied, it is capable of determining a user's location in the virtual reality space, and searching for a virtual beacon based on a user's location, a location where the virtual beacon is generated, and a range of virtual beacon. After searching for a virtual beacon, the virtual reality server 420 is capable of generating a virtual beacon and virtual reality data including information regarding the virtual beacon.

The virtual reality server 420 is capable of transmitting virtual reality data including a virtual beacon to the UE 400 according to the virtual beacon search result in operation 640.

The UE 400 is capable of extracting virtual beacon information from the received virtual reality data in operation 650. The UE 400 is capable of checking whether the extracted virtual beacon is a reception-allowed virtual beacon.

When the UE 400 ascertains that the extracted virtual beacon is a reception-allowed virtual beacon, it is capable of transmitting at least part of the virtual beacon information (e.g., identification information regarding a virtual beacon) to the content provider server 410 in operation 660. The UE 400 is capable of determining information regarding the connection or access to the content provider server 410, via the virtual beacon information.

The UE 400 is capable of receiving information regarding a display mode and content corresponding to a virtual beacon identifier from the content provider server 410 in operation 670. The content provided by the content provider server 410 may include events and services related to a virtual beacon. The information regarding a display mode provided by the content provider server 410 may be information regarding methods of displaying or storing content on the UE 400.

The UE 400 is capable of receiving information regarding content and storing the received information in the database. The UE 400 is capable of receiving part of the information regarding content and accessing the remaining information later.

The UE 400 is capable of displaying content in display mode received from the content provider server 410 and providing the content to the user in operation 680.

As described above, the embodiment is capable of providing a virtual beacon service without the installation of an additional application. In order to prevent the reception of indiscreet virtual beacons, the embodiment may further include a separate virtual beacon management interface. For example, the embodiment may set a type of virtual beacons to be received, a virtual beacon reception-allowed/disallowed area, or a content provider. The virtual beacon management interface may include menus, e.g., display, store, modify, and delete a list of received virtual beacons. The embodiment is capable of determining whether it receives a real beacon related to a virtual beacon or whether it receives content of a real beacon.

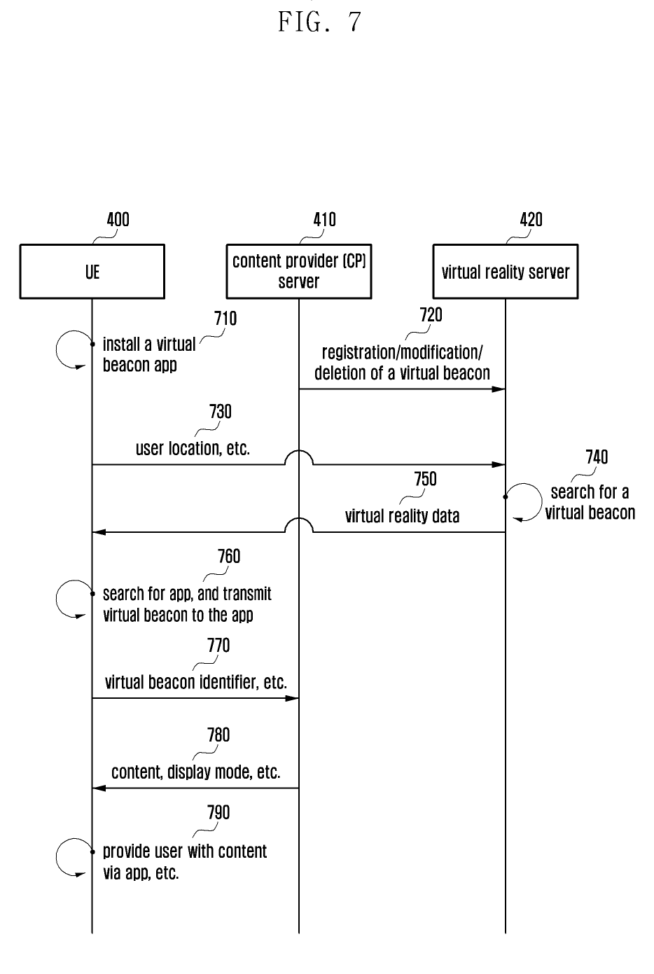

FIG. 7 is a flow diagram illustrating an example second embodiment of an example method of providing a virtual beacon in a virtual reality space.

In order to acquire information related to a virtual beacon via a virtual beacon providing method according to an embodiment, the user installs an application in the UE 400 and is provided virtual beacon-related information via the application in operation 710. When the user installs an application related to a virtual beacon or subscribes for a virtual beacon service via the application, the user may have registered virtual beacons allowed for reception in the UE 400. In this case, only the content or information regarding the registered virtual beacons may be provided to the user or UE 400. In addition, since the content related to virtual beacons or the information regarding a content provider may be acquired via the application, the content provider may not perform the registration of content or information regarding the content provider in the virtual reality server 420 during the registration of virtual beacons. The application may be an application provided by a content provider. The application may be updated by the content provider. The application may be executed independently or dependently on an environment providing the virtual reality. The application may also be an application capable of processing beacons in the real world.

In an embodiment, the UE 400 may set a virtual beacon to be allowed for reception or a virtual beacon to be disallowed for reception. To this end, the UE 400 may have registered/stored a virtual beacon allowed for reception or a virtual beacon disallowed for reception therein via the application.

In an embodiment, the virtual beacon application installed to the UE 400 may include information regarding a content provider and one or more virtual beacons allowed for reception in the UE 400. The UE 400 to which the virtual beacon application has been installed may automatically perform the registration of virtual beacons allowed for reception without a user input. When UE to which the virtual beacon application has not been installed receives a request for registering virtual beacons allowed for reception from the user, the UE searches for an application related to a virtual beacon (e.g., a registration request application, a content provider application, etc.), stores the searched application in the database, and installs it therein.

The embodiment is capable of: receiving only virtual beacons registered in the UE 400; receiving and providing only registered virtual beacons to the user; or providing the user with only content related to registered virtual beacons, thereby preventing virtual beacons or content related to virtual beacons from being indiscreetly provided to the user.

A content provider which needs to provide services via a virtual beacon is capable of registering the virtual beacon related to content (including events or services) in a virtual reality server 420 via a content provider server 410 in operation 720. Content provided via a virtual beacon may include part or all of content which can be provided via a real beacon.

In an embodiment, the content provider is capable of performing the registration, modification and deletion of the virtual beacon information in the virtual reality server 420. For example, the registration of a virtual beacon may be performed in such a way as to determine an area in the virtual space where a virtual beacon can be generated.

The virtual reality server 420 is capable of receiving information regarding a user's location from the UE 400 or directly determining information regarding a user's location in operation 730.

The virtual reality server 420 is capable of searching a database for a virtual beacon related to location information, using a user's location information, etc., in operation 740. When the virtual reality server 420 receives a request from the UE 400 or ascertains that a preset condition (e.g., a case where the user or UE enters a pre-determined place in the virtual space) is satisfied, it is capable of determining a user's location in the virtual reality space, and searching for a virtual beacon based on a user's location, a location where the virtual beacon is generated, and a range of virtual beacon. After searching for a virtual beacon, the virtual reality server 420 is capable of generating a virtual beacon and virtual reality data including information regarding the virtual beacon.

The virtual reality server 420 is capable of transmitting virtual reality data including a virtual beacon to the UE 400 according to the virtual beacon search result in operation 750.

When the UE 400 receives virtual reality data from the virtual reality server 420, it determines whether the virtual reality data includes a registered virtual beacon in operation 760. When the virtual reality data includes a registered virtual beacon, the UE 400 extracts a corresponding virtual beacon from the virtual reality data, searches the database for an application related to the extracted virtual beacon, and transmits the extracted virtual beacon to the application.

The application analyzes the virtual beacon, and provides the content provider server 410 with at least part of the virtual beacon, such as, virtual beacon identification information, etc., in order to additionally acquire content related to the virtual beacon in operation 770. When content is included in a virtual beacon, the application may not perform the communication with the content provider server 410.

When the UE 400 ascertains that the extracted virtual beacon is a reception-allowed virtual beacon, it is capable of transmitting at least part of the virtual beacon information (e.g., identification information regarding a virtual beacon) to the content provider server 410.

The UE 400 is capable of receiving information regarding a display mode and content corresponding to a virtual beacon identifier from the content provider server 410 in operation 780. The content provided by the content provider server 410 may include events and services related to a virtual beacon. The information regarding a display mode provided by the content provider server 410 may be information regarding methods of displaying or storing content on the UE 400.

The UE 400 is capable of receiving information regarding content and storing the received information in the database. The UE 400 is capable of receiving part of the information regarding content and accessing the remaining information later.

The UE 400 is capable of providing the user with content received from the content provider server 410, via the related application stored in the database or in a mode set by the user or the operating system (OS) in operation 790. Alternatively, the UE 400 may convert the content in the format recognizable by the user, based on a user's body information received from the user, and provide the user with the converted content in operation 790.

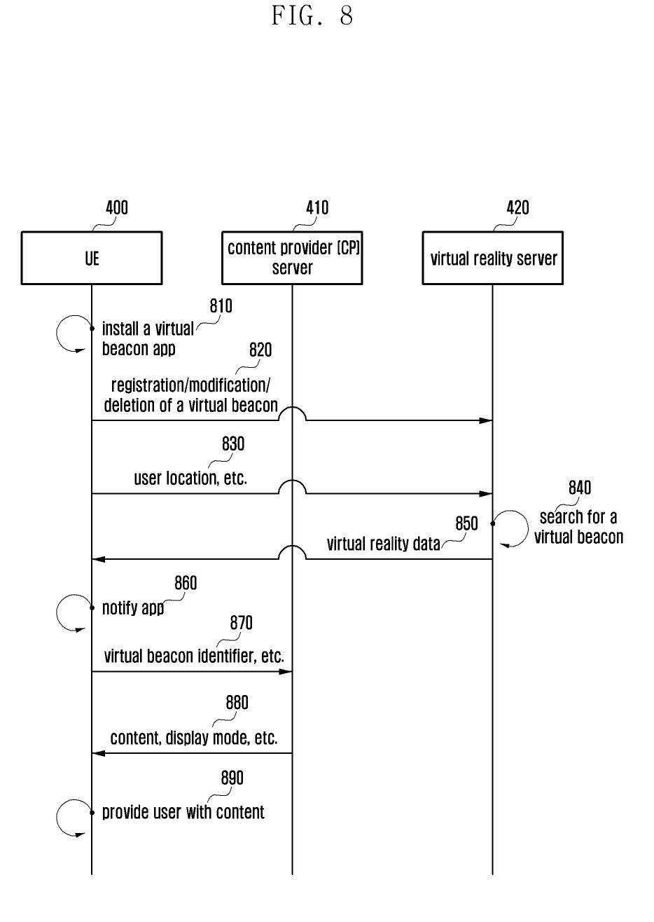

FIG. 8 is a flow diagram illustrating an example third embodiment of an example method of providing a virtual beacon in a virtual reality space.

In order to acquire information related to a virtual beacon via a virtual beacon providing method according to an embodiment, the user installs an application in the UE 400 and is provided virtual beacon-related information via the application in operation 810. When the user installs an application related to a virtual beacon or subscribes for a virtual beacon service via the application, the user may have registered virtual beacons allowed for reception in the UE 400. In this case, only the content or information regarding the registered virtual beacons may be provided to the user or UE 400. In addition, since the content related to virtual beacons or the information regarding a content provider may be acquired via the application, the content provider may not perform the registration of content or information regarding the content provider in the virtual reality server 420 during the registration of virtual beacons.

The application may be an application provided by a content provider. The application may be updated by the content provider. The application may be executed independently or dependently on an environment providing the virtual reality. The application may also be an application capable of processing beacons in the real world.

In an embodiment, the UE 400 may set a virtual beacon to be allowed for reception or a virtual beacon to be disallowed for reception. To this end, the UE 400 may have registered/stored a virtual beacon allowed for reception or a virtual beacon disallowed for reception therein via the application.

In an embodiment, the content provider is capable of providing the UE 400 with a virtual beacon service via a method of providing an application related to the virtual beacon, without directly registering the virtual beacon in the virtual reality server 420.

The UE 400 is capable of registering a virtual beacon in the virtual reality server 420 via the beacon application, and directly or indirectly processing the virtual reality data received from the virtual reality server 420 in operation 820.

In an embodiment, the UE 400 is capable of performing the registration, modification and deletion of the virtual beacon information in the virtual reality server 420.

The virtual reality server 420 is capable of receiving information regarding a user's location from the UE 400 or directly determining information regarding a user's location in operation 830.

The virtual reality server 420 is capable of searching a database for a virtual beacon related to location information, using a user's location information, etc., in operation 840. When the virtual reality server 420 receives a request from the UE 400 or ascertains that a preset condition (e.g., a case where the user or UE enters a pre-determined place in the virtual space) is satisfied, it is capable of determining a user's location in the virtual reality space, and searching for a virtual beacon based on a user's location, a location where the virtual beacon is generated, and a range of virtual beacon. After searching for a virtual beacon, the virtual reality server 420 is capable of generating a virtual beacon and virtual reality data including information regarding the virtual beacon.

The virtual reality server 420 is capable of transmitting virtual reality data including a virtual beacon to the UE 400 according to the virtual beacon search result in operation 850.

The UE 400 is capable of notifying the application of the virtual reality data received from the virtual reality server 420, and extracting information (e.g., a virtual beacon identifier, etc.) to be transmitted to the content provider via the application in operation 860. Alternatively, when the UE 400 ascertains that a virtual beacon is included in the virtual reality data received from the virtual reality server 420, it extracts a virtual beacon, searches the database for an application related to the virtual beacon, and transmits the virtual beacon to the application.

When content related to a virtual beacon exists, the application transmits at least part of the virtual beacon-related information, such as virtual beacon identification information, to the content provider server 410 in operation 870. The content provider server 410 is capable of transmitting, to the UE 400, a display mode and content corresponding to the received virtual beacon information in operation 870.

The UE 400 is capable of receiving information regarding a display mode and content corresponding to a virtual beacon identifier from the content provider server 410 in operation 880. The content provided by the content provider server 410 may include events and services related to a virtual beacon. The information regarding a display mode provided by the content provider server 410 may be information regarding methods of displaying or storing content on the UE 400.

The UE 400 is capable of receiving information regarding content and storing the received information in the database. The UE 400 is capable of receiving part of the information regarding content and accessing the remaining information later.

The UE 400 is capable of providing the user with content received from the content provider server 410, via the related application stored in the database or in a mode set by the user or the operating system (OS) in operation 890. Alternatively, the UE 400 may convert the content in the format recognizable by the user, based on a user's body information received from the user, and provide the user with the converted content.

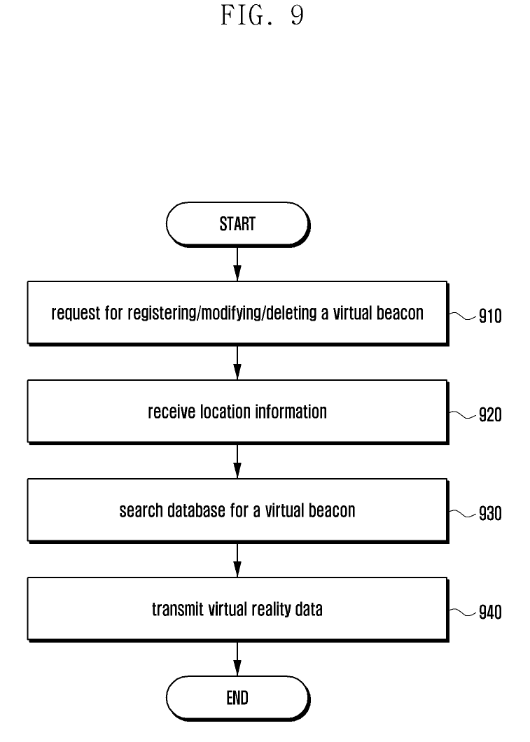

FIG. 9 is a flowchart illustrating an example method for a virtual reality server 420 to provide a user with a virtual beacon according to various example embodiments of the present disclosure.

The virtual reality server 420 is capable of receiving a request from a content provider via the content provider server 410 or a user's request via an application installed to the UE 400 in operation 910. Examples of the request received by the virtual reality server 420 are a request for registering a virtual beacon in a database of the virtual reality server 420, a request for modifying or deleting a virtual beacon in the database, etc. When the virtual reality server 420 receives the request, it is capable of performing the registration, modification and deletion of a virtual beacon in the database according to a management policy for virtual beacons.

In addition to the request for register, modifying and deleting a virtual beacon, the request that the content provider server 410 or the UE 400 transmits to the virtual reality server 420 may include: a location of a virtual beacon, a distance between a virtual beacon in the virtual reality and a user or UE in the virtual reality, a direction between a virtual beacon in the virtual reality and a user or UE in the virtual reality, and information regarding the content provider server 410 for providing content related to virtual beacons.

The virtual reality server 420 is capable of receiving location information regarding UE or the user or directly determining location information regarding UE or the user in operation 920. For example, the location information regarding UE or the user may be GPS coordinates of the location in the real world where the UE 400 is located.

The virtual reality server 420 is capable of searching the database of the virtual reality server 420 for virtual reality data including a virtual beacon related to the location information regarding UE or the user in operation 930. The virtual reality data may include a virtual beacon including the virtual beacon identification information 450.

The database may have been previously established by the operator of the virtual reality server 420. The database is capable of storing information received during the communication between the content provider server 410 and the UE 400. The database is capable of updating the stored information based on newly received information.

After searching the database for a virtual beacon according to the request, the virtual reality server 420 is capable of transmitting, to the UE 400, virtual reality data including a virtual beacon related to location information, etc., in operation 940. The virtual reality server 420 is capable of transmitting, to the UE 400, information regarding a distance between the virtual beacon and the user. The distance information may refer to a numerical value transformed from a distance or a level transformed from a degree of proximity.

The virtual reality server 420 and the content provider server 410 may be the same device. That is, the content provider for providing content related to beacons is capable of operating both the virtual reality server 420 and the content provider server 410.

The virtual reality server 420 may be implemented to be included in the UE 400. For example, an electronic device serving as the UE 400 is configured to include the virtual reality server 420. In this case, the electronic device is capable of providing the virtual space operated in the UE 400 as a virtual reality space.

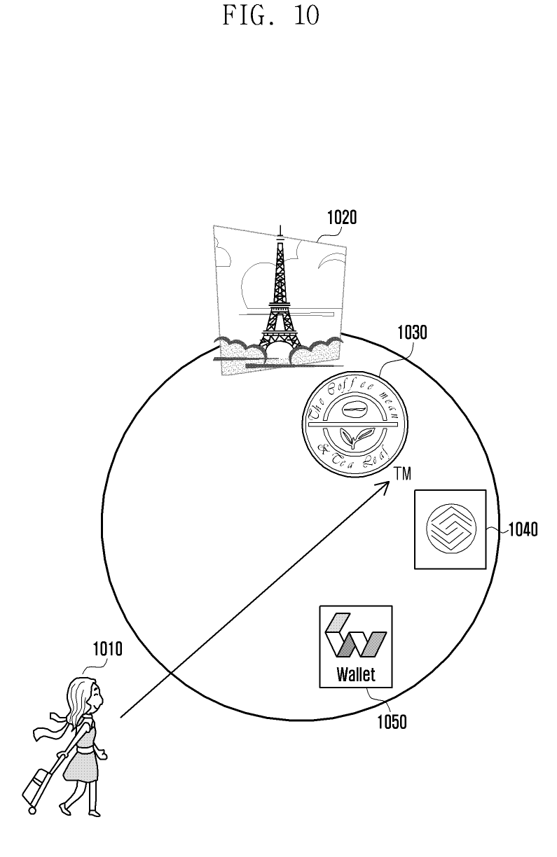

FIG. 10 is a diagram illustrating an example state where a virtual beacon is provided to a user according to various example embodiments of the present disclosure.

A user controlling UE 400 may be located in the virtual reality that the UE 400 implements using virtual reality data provided by the virtual reality server 420. The user may be represented as a character 1010 in the virtual reality, controlled by user inputs. In another embodiment, when the user wears a HMID, the screen output from the HMID may be a virtual reality space represented in a first person perspective view.

For example, a user actually located in New York may be located around the Eiffel Tower 1020 in the virtual reality space that the virtual reality server 420 provides according to the user's selection or information regarding a specific location transmitted by the UE. The virtual space is a simulation space created from the real surrounding area of the Eiffel Tower. A manager at a real Starbucks store 1030 near the Eiffel Tower may install a virtual beacon generating device at a virtual Starbucks store marked as the same location as the real world. When a user connects to the virtual space showing the area around the Eiffel Tower, the user may approach the virtual Starbucks store near the Eiffel Tower and receive the virtual beacon from the virtual beacon generating device installed in the virtual Starbucks store. The received virtual beacon may be stored in the virtual reality server 420 or the UE 400. When the user actually approaches a real Starbucks store near the Eiffel Tower in the real world, the user may receive the real beacon using the virtual beacon which has been received before, or the user may be provided a service including new benefits along with a virtual beacon. In addition, a user in the virtual space may also receive virtual beacons from other virtual stores 1040 and 1050 near the virtual Starbucks store. In this case, according to the settings, the user may receive virtual beacons, simultaneously, from all the virtual stores satisfying a preset condition, e.g., a distance condition, etc., or from only Starbucks stores.

The virtual space around the Eiffel Tower may be implemented with a similar space to the real area around the Eiffel Tower, based on images or map information regarding the real area around the Eiffel Tower. Alternatively, the virtual space around the Eiffel Tower may be created as a space that corresponds to, but does not precisely coincide with, the real area around the Eiffel Tower, according to the settings of the service provider.

As described above, the embodiment allows a user to connect to a virtual reality space via the UE 400 and receive virtual beacons from a content provider in the virtual reality space. In addition, the embodiment is also capable of allowing the user to receive coupons, advertisements containing shopping information, etc., in the virtual reality space. In this case, the user may receive the coupon information via the virtual reality server 420, and advertisements, etc., from the content provider server 410. It should be understood that the present disclosure is not limited to types of materials received in the virtual reality space. For example, a server for providing virtual beacons, coupons or advertisements in the virtual space may be implemented configured according to the settings of the content provider.

In an embodiment of the present disclosure, a method of providing information in virtual reality environment of an electronic device includes: receiving virtual reality data from a first server, based on location information regarding the electronic device, in a virtual reality; extracting virtual beacon information including one or more of the following: a location of the virtual beacon, the direction or distance between the virtual beacon and the terminal in the virtual reality, and information regarding a second server, with identifying information of a virtual beacon, from the received virtual reality data; receiving user context information including information of user related to acquiring the content associated with the virtual beacon; determining whether to transmit the virtual beacon information to the second server, based on the user context information; transmitting at least part of the virtual beacon information to the second server, based on the determination result; receiving content and a display mode from the second server; receiving a user's biometric information; performing the conversion of the content based on the received, user's biometric information; and providing the user with the converted content.

In the method of providing information in virtual reality environment of an electronic device according to an embodiment, the reception of user context information includes: receiving information about at least one of the following: a user's sightlines, the direction of a user's body or face, a user's voice, a user's gesture, and a user's location information; and determining a degree of user interest, based on the received information.

In the method of providing information in virtual reality environment of an electronic device according to an embodiment, the reception of a user's biometric information includes: receiving at least one of the following: a user's visual sensation information, a user's hearing sense information and a user's tactile sensation information.

In the method of providing information in virtual reality environment of an electronic device according to an embodiment, the extraction of virtual beacon information from the received virtual reality data includes: extracting real beacon information containing information corresponding to the virtual beacon information from the received virtual reality data.

In the method of providing information in virtual reality environment of an electronic device according to an embodiment, the method further includes: transmitting, when the electronic device in the real world approaches a location of a real beacon by a preset distance, the real beacon information to the second server; and receiving content corresponding to the real beacon information from the second server.

In the method of providing information in virtual reality environment of an electronic device according to an embodiment, the method further includes: activating real beacon communication mode when the electronic device in the real world approaches a location of a real beacon by a preset distance.

In an embodiment of the present disclosure, a method for a server to provide a virtual beacon includes: receiving virtual beacon information and location information regarding user equipment (a terminal); searching for virtual reality data corresponding to the received location information regarding a terminal and the received virtual beacon information; and transmitting the virtual reality data to the terminal.

In the method for a server to provide a virtual beacon according to an embodiment, the reception of virtual beacon information includes one or more of the following: registration, modification and deletion of the virtual beacon information in the server.

In the method for a server to provide a virtual beacon according to an embodiment, the reception of virtual beacon information includes: receiving the virtual beacon information from a second server that differs from the server.

In the method for a server to provide a virtual beacon according to an embodiment, the reception of virtual beacon information includes: receiving the virtual beacon information from the terminal.

In the method for a server to provide a virtual beacon according to an embodiment, the location information regarding the terminal includes: location information regarding a terminal in a virtual reality and/or location information regarding a real terminal in the real world.

In the method for a server to provide a virtual beacon according to an embodiment, the virtual reality data includes: information regarding a virtual space corresponding to the virtual beacon and the virtual beacon information.

In an embodiment of the present disclosure, a server is implemented to include: at least one database; a communication circuit; a processor electrically connected to the database and the communication circuit; and a memory electrically connected to the processor. The memory stores instructions that enable the processor to: receive virtual beacon information; receive location information regarding user equipment (a terminal); search for virtual reality data corresponding to the received location information regarding the terminal and the received virtual beacon information; and transmit the virtual reality data to the terminal.

In an embodiment of the present disclosure, an electronic device is implemented to include: a display; one or more sensors for detecting the movement of the electronic device; an input unit coupled to or separated from the display; a communication circuit; a processor electrically connected to the display, one or more sensors, the input unit and the communication circuit; and a memory electrically connected to the processor. The memory stores instructions that enable the processor to: receive virtual reality data from a first server, based on location information regarding a terminal, in a virtual reality; extract virtual beacon information including one or more of the following: a location of a virtual beacon, the direction or distance between a virtual beacon and the terminal in the virtual reality, and information regarding a content provider server, with identifying information of a virtual beacon, from the received virtual reality data; receive user context information including information of user related to acquiring the content associated with the virtual beacon; determine whether to transmit the virtual beacon information to a second server, based on the user context information; transmit at least part of the virtual beacon information to the second server, based on the determination result; receive content and a display mode from the second server; receive a user's biometric information; perform the conversion of the content based on the received, user's biometric information; and provide the user with the converted content.

As described above, although the embodiment shows the configuration or architecture of the electronic device, it should be understood that the present disclosure is not limited thereto. For example, the embodiment may be modified in such a way that the individual components are divided into sub-components or the components are re-integrated into one or more modules.

Embodiments of the present disclosure are capable of providing various user experience (UX)/user interface (UI) via virtual beacons generated in a virtual reality.

Embodiments of the present disclosure are capable of providing beacon services, which have not been provided via an existing reality, using virtual beacon information and user context information, and also a new beacon service by mixing a virtual beacon with a real beacon.

It will be understood that the above-described embodiments are examples to help easy understanding of the contents of the present disclosure and do not limit the scope of the present disclosure. Accordingly, the scope of the present disclosure is defined by the appended claims, and it will be construed that all corrections and modifications derived from the meanings and scope of the following claims and the equivalent concept fall within the scope of the present disclosure.

What is claimed is:

1. A method of providing information in virtual reality environment of an electronic device, the method comprising:
receiving virtual reality data from a first server based on location information regarding the electronic device in a virtual reality space;
extracting virtual beacon information including one or more of: a location of the virtual beacon, a direction or distance between the virtual beacon and a terminal in the virtual reality space, and information regarding a second server, with identifying information of a virtual beacon, from the received virtual reality data;
receiving user context information including information of a user related to acquiring the content associated with the virtual beacon;
determining whether to transmit the virtual beacon information to the second server, based on the user context information;
transmitting at least part of the virtual beacon information to the second server, based on the determining;
receiving content and a display mode from the second server;
receiving biometric information of a user;
performing the conversion of the content based on the received biometric information; and
providing the user with the converted content.

2. The method of claim 1, wherein receiving user context information comprises:
receiving information about at least one of: sightlines, the direction of a body or face, a voice, a gesture, and a location information of a user; and
determining a degree of interest, based on the received information.

3. The method of claim 1, wherein receiving biometric information comprises:
receiving at least one of: visual sensation information, hearing sense information and tactile sensation information of a user.

4. The method of claim 1, wherein extracting virtual beacon information from the received virtual reality data comprises:
extracting real beacon information containing information corresponding to the virtual beacon information from the received virtual reality data.

5. The method of claim 4, further comprising:
transmitting real beacon information to the second server when the electronic device in the real world approaches a location of a real beacon by a preset distance; and
receiving content corresponding to the real beacon information from the second server.

6. The method of claim 4, further comprising:
activating a real beacon communication mode when the electronic device in the real world approaches a location of a real beacon by a preset distance.

7. An electronic device comprising:
a display;
one or more sensors configured to detect movement of the electronic device;
an input unit comprising input circuitry coupled to or separated from the display;
a communication circuit;
a processor electrically connected to the display, one or more sensors, the input circuitry of the input unit and the communication circuit; and
a memory electrically connected to the processor,
wherein the memory stores instructions which, when executed, cause the processor to:
display a user interface on the display;
receive an input of a real-world geographic location via the input circuitry of the input unit;
transmit a request for the geographic location to the outside of the electronic device via the communication circuit;
receive view data, related to the geographic location and including at least one location of interest, from the outside of the electronic device via the communication circuit;
display a 3D virtual space on the display based on at least part of the received view data;
track a location of the electronic device located in the virtual space using at least one of: the sensors and the input unit;
receive at least one piece of content related to the location of interest from outside of the electronic device via the communication circuit; and
display at least one piece of content related to the location of interest on the display when the location of the electronic device located in the virtual s pace is within a preset range from the location of interest in the virtual space.

8. The electronic device of claim 7, wherein:
the user interface comprises a map of the real world; and
the input comprises a touch, a voice or a gesture applied to the map.

9. The electronic device of claim 7, wherein:
the user interface comprises a box for an address; and
the input comprises text indicating an address for the real world.

10. The electronic device of claim 7, wherein the instructions, when executed, cause the processor to receive:
view data from a first server; and
at least one piece of content: from a second server; or from the second server via the first server.

11. The electronic device of claim 7, wherein the instructions, when executed, cause the processor to receive: at least one piece of content before the location of the electronic device located in the virtual space is entered in a preset range from the location of interest in the virtual space.

12. The electronic device of claim 7, wherein the instructions, when executed, cause the processor to receive: at least one piece of content after the location of the electronic device located in the virtual space is entered in a preset range from the location of interest in the virtual space.

13. A method for a server to provide a virtual beacon comprising:
receiving virtual beacon information;
receiving location information regarding a terminal;
searching for virtual reality data corresponding to the received location information regarding a terminal and the received virtual beacon information; and
transmitting the virtual reality data to the terminal.

14. The method of claim 13, wherein receiving virtual beacon information comprises at least one of:
deletion, modification, and registration of the virtual beacon information in the server.

15. The method of claim 14, wherein receiving virtual beacon information comprises:
receiving the virtual beacon information from a second server that differs from the server.

16. The method of claim 14, wherein receiving virtual beacon information comprises:
receiving the virtual beacon information from the terminal.

17. The method of claim 13, wherein the location information regarding the terminal comprises:
location information regarding a terminal in a virtual reality space and/or location information regarding a real terminal in the real world.

18. The method of claim 13, wherein the virtual reality data comprises:
information regarding a virtual space corresponding to the virtual beacon and the virtual beacon information.
